(19) United States
(12) Patent Application Publication
(10) Pub. No.: US 2002/0001020 A1
(43) Pub. Date: Jan. 3, 2002

(54) HEATER CHIP MODULE FOR USE IN AN INK JET PRINTER

(76) Inventors: JAMES MICHAEL MRVOS, LEXINGTON, KY (US); ASHOK MURTHY, LEXINGTON, KY (US)

Correspondence Address: JOHN J MCARDLE JR, LEXMARK INTERNATIONAL INC, INTELLECTUAL PROPERTY LAW DEPARTMENT, 740 NEW CIRCLE ROAD N W, LEXINGTON, KY, 40550

(21) Appl. No.: 09/100,538

(22) Filed: Jun. 19, 1998

(51) Int. Cl. B41J 2/14

(52) U.S. Cl. 347/65; 347/50

(57) ABSTRACT

A heater chip module is provided comprising a carrier adapted to be secured to an ink-filled container, at least one heater chip having a base coupled to the carrier, and at least one nozzle plate coupled to the heater chip. The carrier includes a support section provided with at least one passage which defines a path for ink to travel from the container to the heater chip. The heater chip is secured at its base to the support section.

### CROSS-REFERENCE TO RELATED APPLICATIONS

This application is related to contemporaneously filed patent applications U.S. Ser. No. ______, entitled “AN INK JET HEATER CHIP MODULE WITH SEALANT MATERIAL,” having Attorney Docket No. LE9-97-109; U.S. Ser. No. ______, entitled “A HEATER CHIP MODULE AND PROCESS FOR MAKING SAME,” having Attorney Docket No. LE9-97-115; U.S. Ser. No. ______, entitled “A PROCESS FOR MAKING A HEATER CHIP MODULE,” having Attorney Docket No. LE9-97-111; U.S. Ser. No. ______, entitled “AN INK JET HEATER CHIP MODULE INCLUDING A NOZZLE PLATE COUPLING A HEATER CHIP TO A CARRIER,” having Attorney Docket No. LE9-98-003; and U.S. Ser. No. ______, entitled “AN INK JET HEATER CHIP MODULE,” having Attorney Docket No. LE9-97-064, the disclosures of which are incorporated herein by reference.

### FIELD OF THE INVENTION

This invention relates to an ink jet heater chip module adapted to be secured to an ink-filled container.

### BACKGROUND OF THE INVENTION

Drop-on-demand ink jet printers use thermal energy to produce a vapor bubble in an ink-filled chamber to expel a droplet. A thermal energy generator or heating element, usually a resistor, is located in the chamber on a heater chip near a discharge nozzle. A plurality of chambers, each provided with a single heating element, are provided in the printer's printhead. The printhead typically comprises the heater chip and a nozzle plate having a plurality of the discharge nozzles formed therein. The printhead forms part of an ink jet print cartridge which also comprises an ink-filled container.

A plurality of dots comprising a swath of printed data are printed as the ink jet print cartridge makes a single scan across a print medium, such as a sheet of paper. The data swath has a given length and width. The length of the data swath, which extends transversely to the scan direction, is determined by the size of the heater chip.

Printer manufacturers are constantly searching for techniques which may be used to improve printing speed. One possible solution involves using larger heater chips. Larger heater chips, however, are costly to manufacture. Heater chips are typically formed on a silicon wafer having a generally circular shape. As the normally rectangular heater chips get larger, less of the silicon wafer can be utilized in making heater chips. Further, as heater chip size increases, the likelihood that a chip will have a defective heating element, conductor or other element formed thereon also increases. Thus, manufacturing yields decrease as heater chip size increases.

Accordingly, there is a need for an improved printhead or printhead assembly which allows for increased printing speed yet is capable of being manufactured in an economical manner.

### SUMMARY OF THE INVENTION

In accordance with the present invention, a heater chip module is provided comprising a rigid carrier, a heater chip and a nozzle plate. The carrier is adapted to be secured directly to a container for receiving ink. It includes a support section. The heater chip is coupled to the carrier support section. The support section includes at least one passage which defines a path for ink to travel from the container to the heater chip. The nozzle plate is coupled to the heater chip.

Two or more heater chips, aligned end to end or at an angle to one another, may be coupled to a single carrier. Thus, two or more smaller heater chips can be combined to create the effect of a single, larger heater chip. That is, two or more smaller heater chips can create a data swath that is essentially equivalent to one printed by a substantially larger heater chip.

Each of two or more heater chips coupled to a single carrier may be dedicated to a different color. For example, three heater chips positioned side by side may be coupled to a single carrier, wherein each heater chip receives ink of one of the three primary colors.

Preferably, the carrier is formed from a thermally conductive material such as a ceramic metallic composite, a metal, a ceramic or silicon. The thermally conductive material provides a dissipation path for heat generated by the one or more heater chips coupled to the carrier.

Because the rigid carrier does not expand or contract significantly in response to temperature or humidity changes experienced during printing, the spacing between adjacent heater chips coupled to a single carrier does not vary significantly. Further, because “good” chips, i.e., chips which have passed quality control testing, are assembled to the carrier, higher manufacturing yields are achieved.

Bond pads on the heater chips can be coupled to traces on one or more flexible circuits via wire-bonding. Separate wires extend between sections of the traces to the bond pads on the heater chip. The trace sections and the bond pads are substantially coplanar with a bottom surface of the nozzle plate. Further, the wires are generally positioned between a bottom surface of the ink-filled container, which surface is closest to a paper substrate being printed, and the paper substrate.

In the illustrated embodiment, the heater chip module comprises a “top shooter” module or printhead, wherein the nozzles are in a direction normal to the surfaces of the resistive heating elements on the heater chip(s).

### BRIEF DESCRIPTION OF THE DRAWINGS

FIG. 1 is a perspective view, partially broken away, of an ink jet printing apparatus having a print cartridge constructed in accordance with the present invention;

FIG. 2 is a plan view of a portion of a heater chip module constructed in accordance with a first embodiment of the present invention;

FIG. 2A is a view taken along view line 2A-2A in FIG. 2;

FIG. 2B is a view taken along view line 2B-2B in FIG. 2;

FIG. 2C is a plan view of the support substrate, spacer and heater chip of the module illustrated in FIGS. 2, 2A and 2B with the nozzle plate and flexible circuit removed

FIG. 2D is a cross sectional view of a portion of a flexible circuit of the module illustrated in FIG. 2;

FIG. 3 is a cross sectional view of a portion of a heater chip module constructed in accordance with a second embodiment of the present invention;

FIG. 4 is a plan view of a portion of the heater chip module illustrated in FIG. 3; and

FIGS. 5 and 6 are cross sectional views of portions of heater chip modules constructed in accordance with further embodiments of the present invention.

### DETAILED DESCRIPTION OF PREFERRED EMBODIMENTS

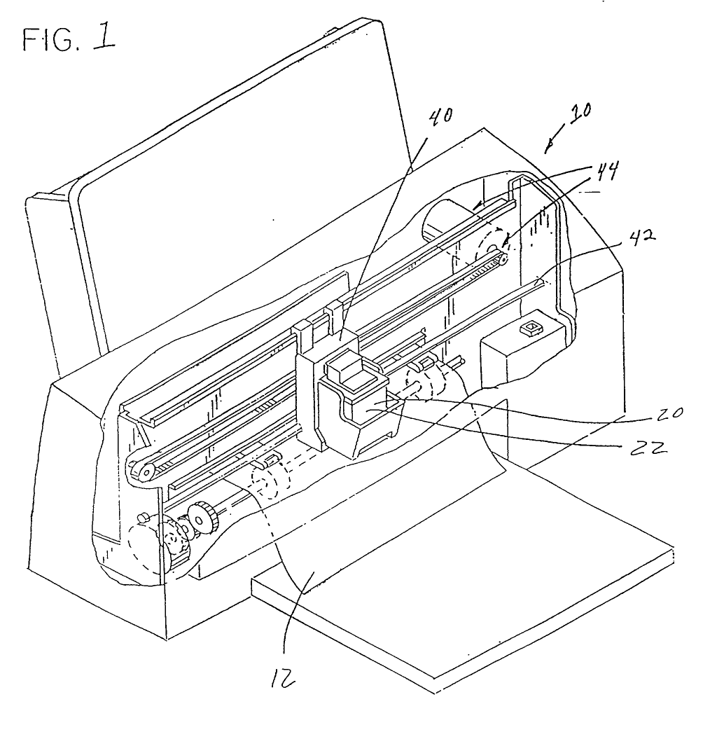

Referring now to FIG. 1, there is shown an ink jet printing apparatus 10 having a print cartridge 20 constructed in accordance with the present invention. The cartridge 20 is supported in a carriage 40 which, in turn, is slidably supported on a guide rail 42. A drive mechanism 44 is provided for effecting reciprocating movement of the carriage 40 and the print cartridge 20 back and forth along the guide rail 42. As the print cartridge 20 moves back and forth, it ejects ink droplets onto a paper substrate 12 provided below it.

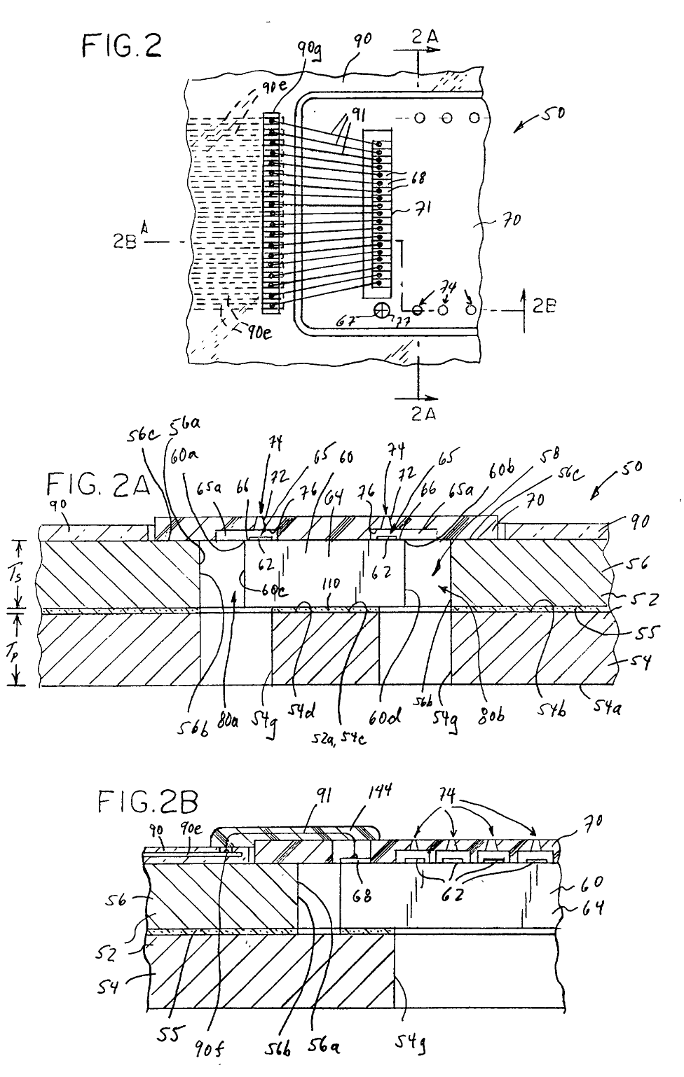

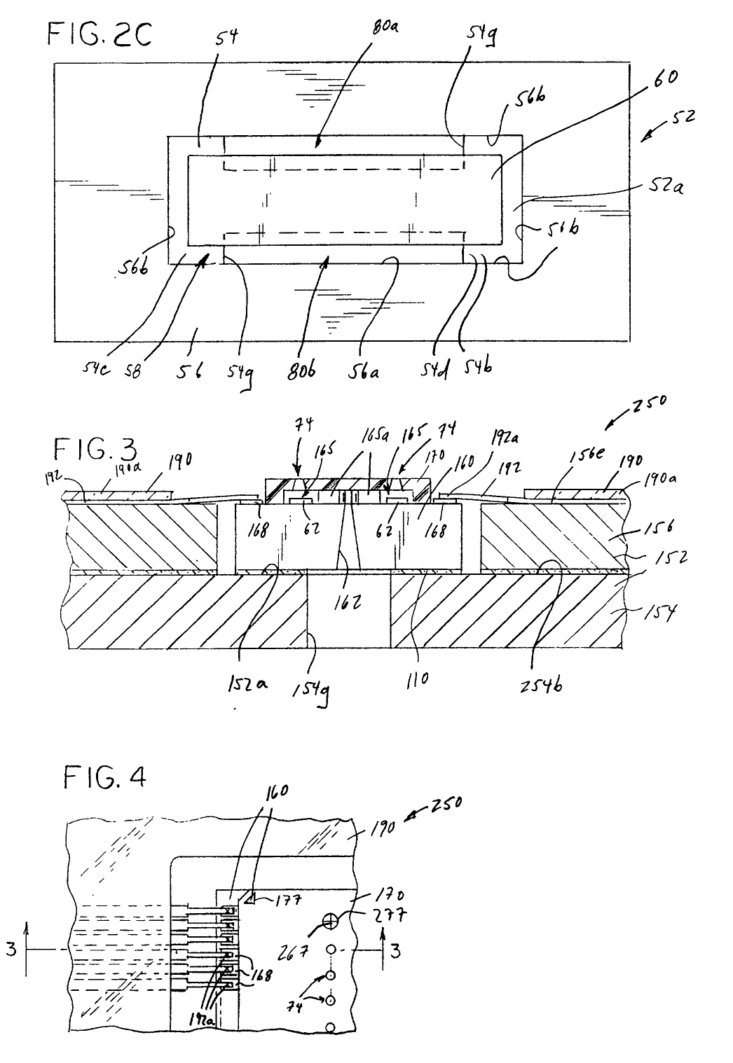

The print cartridge 20 comprises a container 22, shown only in FIG. 1, filled with ink and a heater chip module 50, shown in FIG. 2. The container 22 may be formed from a polymeric material. In the illustrated embodiment, the container 22 is formed from polyphenylene oxide, which is commercially available from the General Electric Company under the trademark “NORYL SE-1.” The container 22 may be formed from other materials not explicitly set out herein.

In the embodiment illustrated in FIG. 2, the module 50 comprises a substantially rigid carrier 52, an edge-feed heater chip 60 and a nozzle plate 70. The heater chip 60 includes a plurality of resistive heating elements 62 which are located on a base 64. In the illustrated embodiment, the base 64 is formed from silicon. The nozzle plate 70 has a plurality of openings 72 extending through it which define a plurality of nozzles 74 through which ink droplets are ejected. The carrier 52 is secured directly to a bottom side (not shown) of the container 22, i.e., the side in FIG. 1 closest to the paper substrate 12, such as by an adhesive (not shown). Thus, in the illustrated embodiment, there is no other element positioned between the carrier 52 and the container 22 except for the adhesive. An example adhesive which may be used for securing the carrier 52 to the container 22 is one which is commercially available from Emerson and Cuming Specialty Polymers, a division of National Starch and Chemical Company under the product designation “ECCOBOND 3193-17.”

The nozzle plate 70 may be formed from a flexible polymeric material substrate which is adhered to the heater chip 60 via an adhesive (not shown). Examples of polymeric materials from which the nozzle plate 70 may be formed and adhesives for securing the plate 70 to the heater chip 60 are set out in commonly assigned patent application, U.S. Ser. No. 08/966,281, entitled “METHOD OF FORMING AN INKJET PRINTHEAD NOZZLE STRUCTURE,” by Ashok Murthy et al., filed on Nov. 7, 1997, which is a continuation-in-part application of patent application, U.S. Ser. No. 08/519,906, entitled “METHOD OF FORMING AN INKJET PRINTHEAD NOZZLE STRUCTURE,” by Tonya H. Jackson et al., filed on Aug. 28, 1995, the disclosures of which are hereby incorporated by reference. As noted therein, the plate 70 may be formed from a polymeric material such as polyimide, polyester, fluorocarbon polymer, or polycarbonate, which is preferably about 15 to about 200 microns thick, and most preferably about 20 to about 80 microns thick. Examples of commercially available nozzle plate materials include a polyimide material available from E.I. DuPont de Nemours & Co. under the trademark “KAPTON” and a polyimide material available from Ube (of Japan) under the trademark “UPILEX.” The adhesive for securing the plate 70 to the heater chip 60 may comprise a phenolic butyral adhesive. The nozzle plate 70 may be is bonded to the chip 60 via any technique such as a thermocompression bonding process. A polyimide substrate/phenolic butyral adhesive composite material is commercially available from Rogers Corporation, Chandler, AZ, under the product name “RFLEX 1100.” An intermediate Photoimageable planarizing epoxy layer (as disclosed in U.S. application Ser. No. 09/064,019, filed Apr. 21, 1998) is employed between the heater chip 60 and the adhesive composite material.

When the plate 70 and the heater chip 60 are joined together, sections 76 of the plate 70 and portions 66 of the heater chip 60 define a plurality of bubble chambers 65. Ink supplied by the container 22 flows into the bubble chambers 65 through ink supply channels 65a. As is illustrated in FIG. 2A, the supply channels 65a extend from the bubble chambers 65 beyond first and second outer edges 60a and 60b of the heater chip 60. The resistive heating elements 62 are positioned on the heater chip 60 such that each bubble chamber 65 has only one heating element 62. Each bubble chamber 65 communicates with one nozzle 74.

In the embodiment illustrated in FIGS. 2, 2A, and 2B, the carrier 52 comprises a support substrate 54 and a spacer 56 secured to the support substrate 54. The spacer 56 has a generally rectangular opening 56a defined by inner side walls 56b. The support substrate 54 has first and second outer surfaces 54a and 54b and a portion 54c which defines a carrier support section 52a to which the edge feed heater chip 60 is secured. An upper surface 54d of the support substrate portion 54c and the inner side walls 56b of the spacer 56 define an inner cavity 58 of the carrier 52. The edge feed heater chip 60 is located in the carrier inner cavity 58 and secured to the carrier support section 52a. The support substrate 54 has a thickness T_{P} of from about 400 microns to about 1000 microns and, preferably, from about 500 microns to about 800 microns. The spacer 56 has a thickness Ts of from about 400 microns to about 1000 microns and, preferably, from about 500 microns to about 800 microns.

The portion 54c includes two passages 54g extending from the first outer surface 54a of the support substrate 54 to the inner cavity 58. Hence, the passages 54g communicate with the inner cavity 58 so as to define paths for ink to travel from the container 22 to the inner cavity 58. From the inner cavity 58, the ink flows into the ink supply channels 65a. The passages 54g have a generally rectangular shape in the illustrated embodiment. They may, however, have an elliptical or other geometric shape. Further, each passage 54g may comprise a plurality of smaller passages or channels which are spaced apart from one another.

The support substrate 54 is preferably formed from a thermally conductive material. Example thermally conductive materials include ceramics, including ceramic metallic composites, silicon, and metals, such as stainless steel, aluminum, copper, zinc, nickel and alloys thereof. In the illustrated embodiment, the support substrate 54 is formed from steel using any process for making cut metal sheet parts such as stamping, chemical etching, or laser cutting. The thermally conductive material provides a dissipation path for heat generated by the heater chip 60 coupled to the carrier 52.

The spacer 56 may be formed from a metal such as steel, aluminum, copper, zinc and nickel, or from a moldable, machinable or otherwise formable polymeric material such as a polyetherimide, which is commercially available from GE Plastics under the product name “ULTEM.”

The spacer 56 is secured to the support substrate 54 by an adhesive 55. Example adhesives which may be used for securing the spacer 56 to the support substrate 54 include a thermally curable B-stage adhesive (polysulfone) film preform which is commercially available from Alpha Metals Inc. under the product designation “Staystik 415” and another adhesive material which is commercially available from Mitsui Toatsu Chemicals Inc. under the product designation “REGULUS.”

It is further contemplated that two or more inner cavities 58 and a like number of substrate portions 54c may be formed in a single carrier 52 such that the single carrier 52 is capable of receiving two or more heater chips 60. It is also contemplated that two or more heater chips 60 may be provided in a single inner cavity 58 and secured to a single substrate portion 54c. In either of the two alternative embodiments, the heater chips 60 may be positioned side by side, end to end or at an angle to one another.

If two or more heater chips 60 are coupled to a single carrier 52, a like number of nozzle plates 70 may be provided such that a separate nozzle plate 70 is coupled to each heater chip 60. Alternatively, a single, much larger nozzle plate (not shown) may be provided to which the two or more heater chips 60 are coupled.

The inner cavity 58 and the heater chip 60 are sized such that opposing side portions 60c and 60d of the heater chip 60 are spaced from adjacent inner side walls 56b of the spacer 56 to form gaps 80a and 80b of a sufficient size to permit ink to flow freely between the chip side portions 60c and 60d and the adjacent inner side walls 56b, see FIG. 2A.

The nozzle plate 70 is sized to extend over an outer portion 56c of the spacer 56 surrounding the inner cavity 58 such that the inner cavity 58 is sealed to prevent ink from leaking from the cavity 58. As noted above, the passages 54g provide paths for ink to travel from the container 22 to the inner cavity 58. From the inner cavity 58, the ink flows into the ink supply channels 65a.

The resistive heating elements 62 are individually addressed by voltage pulses provided by a printer energy supply circuit (not shown). Each voltage pulse is applied to one of the heating elements 62 to momentarily vaporize the ink in contact with that heating element 62 to form a bubble within the bubble chamber 65 in which the heating element 62 is located. The function of the bubble is to displace ink within the bubble chamber 65 such that a droplet of ink is expelled from a nozzle 74 associated with the bubble chamber 65.

A flexible circuit 90, secured to the container 22 and the carrier 52, is used to provide a path for energy pulses to travel from the printer energy supply circuit to the heater chip 60. As shown in FIG. 2D, the flexible circuit 90 comprises first and second outer substrate layers 90a and 90b formed from a polymeric material such as a polyimide or polyester_material, first and second inner adhesive layers 90c and 90d comprising, for example, an acrylic, polyester, phenolic or epoxy adhesive material, and metal traces 90e, copper in the illustrated embodiment, positioned between the adhesive and polymeric layers.

In the illustrated embodiment, the flexible circuit 90 is formed by providing a laminate comprising a substrate layer 90b, an adhesive layer 90d and a sheet of copper material. Such a laminate is commercially available from E.I. DuPont de Nemours & Co. under the product designation “Pyralux WA/K Copper Clad Laminate.” A photoresist material, such as a negative photoresist material, is applied to the copper sheet. A mask, having a plurality of blocked or covered areas and unblocked areas, is positioned over the photoresist material. The unblocked portions of the mask correspond to the traces. Thereafter, unblocked portions of the photoresist are exposed to ultraviolet light to effect curing or polymerization of the exposed portions. The unexposed or uncured portions are then removed using a conventional developer. The pattern formed in the photoresist layer is transferred to the copper sheet using a conventional etching process. After etching has been completed, the photoresist material remaining on the copper sheet is removed via a conventional stripping process. Finally, a laminate comprising a substrate layer 90a and an adhesive layer 90c, one of which is commercially available from E.I. DuPont de Nemours & Co. under the product designation “Pyralux WA/K Bond Ply” is laminated to the traces 90e and the substrate and adhesive layers 90b and 90d via a hot press process. Preferably, the substrate and adhesive layers 90a and 90c are prepunched so as to include one or more openings 90g therein before being laminated to the layers 90b, 90d and 90e.

The bond pads 68 on the heater chip 60 are wire-bonded to sections 90f of the traces 90e within the flexible circuit 90 such that a single wire 91 extends from each bond pad 68, through an opening 90g in the flexible circuit 90, to a section 90f of a metal trace 90e, see FIGS. 2 and 2D. The wires 91 further extend through windows or openings 71 formed in the nozzle plate 70. It is also contemplated that the nozzle plate 70 may be sized as described in the above-referenced patent application entitled “AN INK JET HEATER CHIP MODULE WITH SEALANT MATERIAL” such that the wires 91 do not extend through windows in the nozzle plate 70. Current flows from the printer energy supply circuit to the traces 90e within the flexible circuit 90 and from the traces 90e to the bond pads 68 on the heater chip 60. Conductors (not shown) are formed on the heater chip base 64 and extend from the bond pads 68 to the heating elements 62. The current flows from the bond pads 68 along the conductors to the heating elements 62. Alternatively, a flexible circuit having traces which are TAB bonded to bond pads on a heater chip, such as described in copending patent application U.S. Ser. No. 08/827,140, entitled “A PROCESS FOR JOINING A FLEXIBLE CIRCUIT TO A POLYMERIC CONTAINER AND FOR FORMING A BARRIER LAYER OVER SECTIONS OF THE FLEXIBLE CIRCUIT AND OTHER ELEMENTS USING AN ENCAPSULANT MATERIAL,” filed Mar. 27, 1997, the disclosure of which is incorporated herein by reference, may be used in place of the circuit 90 described above.

The process for forming the heater chip module 50 illustrated in FIG. 2 will now be described for a wire-bond embodiment. As noted above, the nozzle plate 70 comprises a flexible polymeric material substrate. In the illustrated embodiment, the flexible substrate is provided with an overlaid layer of phenolic butyral adhesive for securing the nozzle plate 70 to the heater chip 60 and the carrier 52.

Initially, the nozzle plate 70 is aligned with and mounted to the heater chip 60. At this point, the heater chip 60 has been separated from other heater chips 60 formed on the same wafer. Alignment takes place as follows. One or more openings 77 are provided in the nozzle plate 70 which arc aligned with one or more fiducials 67 formed on the heater chip 60. After the nozzle plate 70 is aligned to and located on the heater chip 60, the plate 70 is tacked to the heater chip 60 using, for example, a conventional thermocompression bonding process. The phenolic butyral adhesive on the nozzle plate 70 is not cured after the tacking step has been completed.

If two or more heater chips 60 are coupled to a single, larger nozzle plate, alignment of the heater chips 60 to the nozzle plate is effected in substantially the same manner. That is, openings in the single, larger nozzle plate are aligned with fiducials provided on the two or more heater chips 60.

Either before or after the nozzle plate 70 is tacked to the heater chip 60, the spacer 56 is bonded to the support substrate 54. A layer of the adhesive 55, examples of which are noted above, is applied to the second outer surface 54b of the support substrate 54 where the spacer 56 is to be positioned. The spacer 56 is then mounted to the support substrate 54. Thereafter, the adhesive 55 is fully cured using heat and pressure.

A further adhesive material (not shown), such as a 0.002 inch thick, die-cut phenolic adhesive film, which is commercially available from Rogers Corporation (Chandler, Ariz.) under the product designation “1000B200,” is placed on a portion of the carrier 52 to which the flexible circuit 90 is to be secured. After the adhesive film is placed on the carrier, the flexible circuit 90 is positioned over the adhesive film and tacked to the carrier 52 using heat and pressure.

The nozzle plate/heater chip assembly is then mounted to the carrier 52. Initially, a conventional die bond adhesive 110, such as a thermally conductive die bond adhesive, one of which is commercially available from Alpha Metals Inc. under the product designation “Polysolder LT,” is applied to the upper surface 54d of the substrate portion 54c at locations where one or more heater chips 60 are to be located. Thereafter, openings (not shown) in the nozzle plate 70 are aligned with structural features (not shown) on the carrier 52.

The nozzle plate/heater chip assembly is tacked to the carrier 52 so as to maintain the assembly and the carrier 52 joined together until the die bond adhesive 110 is cured. Before the nozzle plate/heater chip assembly is aligned with and mounted to the carrier 52, a conventional ultraviolet (UV) curable adhesive (not shown), such as one which is commercially available from Emerson and Cuming Specialty Polymers, a division of National Starch and Chemical Company under the product designation UV9000, is applied to one or more locations on the carrier 52 where corners of the heater chip 60 are to be located. After the nozzle plate/heater chip assembly is mounted to the carrier 52, exposed UV adhesive is cured using ultraviolet radiation to effect tacking. It is also contemplated that a conventional cationic cured adhesive material may be used for tacking the heater chip 60 to the carrier 52. One such adhesive is commercially available from Electronic Materials Inc. under the product designation “Emcast 700 Series.” This material is also cured via UV radiation.

Next, the nozzle plate/heater chip assembly and the support substrate/spacer assembly are heated in an oven at a temperature and for a time period sufficient to effect the curing of the following materials: the phenolic butyral adhesive that bonds the nozzle plate 70 to the heater chip 60 and the carrier 52; the phenolic adhesive film which joins the flexible circuit 90 to the carrier 52; and the die bond adhesive 10 which joins the heater chip 60 to the substrate portion 54c.

After the nozzle plate/heater chip assembly and the flexible circuit 90 have been bonded to the carrier 52, sections 90f of the traces 90e on the flexible circuit 90 are wire-bonded to the bond pads 68 on the heater chip 60. It is also contemplated that trace end sections may be coupled to the bond pads via a conventional Tape Automated Bonding (TAB) process such as described in the above referenced patent application entitled “AN INK JET HEATER CHIP MODULE INCLUDING A NOZZLE PLATE COUPLING A HEATER CHIP TO A CARRIER.” After wire-bonding or TAB bonding, a liquid encapsulant material 144 (shown only in FIG. 2B), such as an ultraviolet (UV) curable adhesive, one of which is commercially available from Emerson and Cuming Specialty Polymers, a division of National Starch and Chemical Company under the product designation “LV9000,” is applied over the trace sections 90f, the bond pads 68, the windows 71 and the wires 91 extending between the trace sections and the bond pads. The UV adhesive is then cured using ultraviolet light.

The heater chip module 50, which comprises the nozzle plate/heater chip assembly and the carrier 52, and to which the flexible circuit 90 is bonded, is aligned with and bonded to a polymeric container 22. An adhesive (not shown) such as one which is commercially available from Emerson and Cuming Specialty Polymers, a division of National Starch and Chemical Company under the product designation “ECCOBOND 3193-17” is applied to a portion of the container where the module 50 is to be located. The module 50 is then mounted to the container portion.

Next, the heater chip module 50 and container 22 are heated in an oven at a temperature and for a time period sufficient to effect the curing of the adhesive which joins the module 50 to the container 22.

A portion of the flexible circuit 90 which is not joined to the carrier 52 is bonded to the container 22 by, for example, a conventional free-standing pressure sensitive adhesive film, such as described in copending patent application U.S. Ser. No. 08/827,140, entitled “A PROCESS FOR JOINING A FLEXIBLE CIRCUIT TO A POLYMERIC CONTAINER AND FOR FORMING A BARRIER LAYER OVER SECTIONS OF THE FLEXIBLE CIRCUIT AND OTHER ELEMENTS USING AN ENCAPSIJLANT MATERIAL,” filed Mar. 27, 1997, the disclosure of which is incorporated herein by reference.

It is also contemplated that the heater chip 60 may be secured to the carrier 52 by eutectic bonding or any other known bonding process.

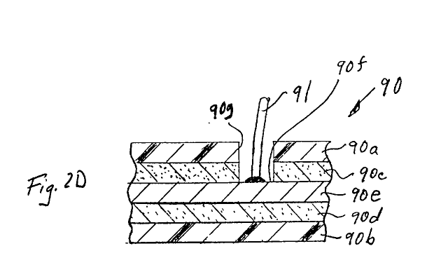

A heater chip module 250, formed in accordance with a second embodiment of the present invention, is shown in FIGS. 3 and 4, wherein like reference numerals indicate like elements. Here, the support substrate 154 of the carrier 152 is formed having only one passage 154g for each heater chip 160. The heater chip 160 comprises a conventional center feed heater chip having a center ink-receiving via 162. Ink from the container 22 travels through the passage 154g in the support substrate 154 to the via 162. From the via 162, the ink passes through supply channels 165a in the nozzle plate 170 to bubble channels 165 defined by portions of the heater chip 160 and sections of the nozzle plate 170.

The support substrate 154 and spacer 156 may be formed from substantially the same materials from which the support substrate 54 and spacer 56 in the FIG. 2 embodiment are formed. However, only one passage 154g is formed in the support substrate 154 for each heater chip 160.

Assembly of the components of the heater chip module 250 may occur in the following manner. Initially, the nozzle plate 170 is aligned with and mounted to the heater chip 160. Typically, a plurality of heater chips 160 are formed on a single wafer. In this embodiment, a nozzle plate 170 is mounted to each heater chip 160 before the wafer is diced. Alignment may take place as follows. One or more openings 277 are formed in a nozzle plate 170 which are aligned with one or more fiducials 267 formed on a heater chip 160. After each nozzle plate 170 is aligned to and located on a corresponding heater chip 160, the plate 170 is tacked to that heater chip 160. It is further contemplated that a single, larger nozzle plate (not shown) could be bonded to two or more heater chips. In such an embodiment, the heater chips are aligned with the nozzle plate 170 after the heater chips have been separated from the heater chip wafer.

The nozzle plate 170 includes one or more openings 177 which, in the illustrated embodiment, are triangular in shape, see FIG. 4. The openings 177 may be circular, square or have another geometric shape. An ultraviolet (UV) curable adhesive (not shown), such as one which is commercially available from Emerson and Cuming Specialty Polymers, a division of National Starch and Chemical Company under the product designation LV-4359-88 is applied over the openings 177 so as to contact both the nozzle plate 170 and the heater chip 160. Thereafter, the adhesive is cured using UV radiation to effect tacking. Each heater chip 160 on the heater chip wafer receives a nozzle plate 170 which is tacked to its corresponding heater chip 160 in this manner. After tacking has been completed, the nozzle plates 170 are permanently bonded to the heater chips 160 on the wafer by curing the layer of phenolic butyral adhesive provided on the underside of each nozzle plate 170 using, for example, a conventional thermocompression bonding process. Thereafter, the heater chip wafer is diced so as to separate the nozzle plate/heater chip assemblies from one another.

After the heater chip wafer has been diced, a flexible circuit 190 is attached to the heater chip 160 of each nozzle plate/heater chip assembly. End sections 192a of traces 192 on the flexible circuit 190 are TAB bonded to the bond pads 168 on the heater chip 160, see FIGS. 3 and 4. In this embodiment, the flexible circuit 190 comprises a single layer substrate, such as a polyimide substrate 190a, and copper traces 192 which are formed on the underside of the substrate 190a. It is also contemplated that trace sections may be coupled to the bond pads 168 via a wire-bonding process. However, such a wire-bonding step would most likely occur after the flexible circuit 190 is attached to the spacer 156.

Either before or after the nozzle plate 170 is tacked to the heater chip 160, the spacer 156 is bonded to the support substrate 154 using the same process and adhesive described above for bonding the spacer 56 to the support substrate 54.

A further adhesive material (not shown), such as a 0.002 inch die-cut phenolic adhesive film, which is commercially available from Rogers Corporation under the product designation “1000B200,” is placed on a portion 156e of the spacer 156 to which the flexible circuit 190 is to be secured.

After the nozzle plate 170 has been bonded to the heater chip 160, the spacer 156 has been bonded to the support substrate 154, and the phenolic adhesive film has been placed on the spacer 156, the nozzle plate/heater chip assembly is aligned with and tacked to the support substrate/spacer assembly. Initially, a die bond adhesive 110 is applied to a carrier support section 152a where the heater chip 160 is to be located.

Thereafter, openings (not shown) in the nozzle plate 170 are aligned with structural features (not shown) on the carrier 152.

The nozzle plate/heater chip assembly is tacked to the support substrate/spacer assembly, i.e., the carrier 152, so as the maintain the two assemblies joined together until the die bond adhesive 110 is cured. Before the nozzle plate/heater chip assembly is mounted onto the support substrate/spacer assembly, a conventional ultraviolet (UV) curable adhesive (not shown), such as one which is commercially available from Emerson and Cuming Specialty Polymers, a division of National Starch and Chemical Company under the product designation UV9000, is applied to one or more locations on the support substrate 154 where corners of the heater chip 160 are to be positioned. After the nozzle plate/heater chip assembly is mounted to the support substrate/spacer assembly, exposed adhesive is cured using ultraviolet radiation to effect tacking. Once the nozzle plate/heater chip assembly is mounted to the support substrate/spacer assembly, the flexible circuit 190 contacts the phenolic adhesive film placed on the spacer 156.

Next, the nozzle plate/heater chip assembly and the support substrate/spacer assembly are heated in an oven at a temperature and for a time period sufficient to effect the curing of the following materials: the phenolic adhesive film which joins the flexible circuit 190 to the spacer 156 and the die bond adhesive 110 which joins the heater chip 160 to the support substrate 154.

A liquid encapsulant material (not shown) such as an ultraviolet (UV) curable adhesive, one of which is commercially available from Emerson and Cuming Specialty Polymers, a division of National Starch and Chemical Company under the product designation UV9000, is then applied over the trace end sections 192a and the bond pads 168. Thereafter, the UV adhesive is cured using UV light.

The heater chip module 250, which comprises the nozzle plate/heater chip assembly and the support substrate/spacer assembly, and to which the flexible circuit 190 is bonded, is aligned with and bonded directly to a polymeric container 22. An adhesive (not shown) such as one which is commercially available from Emerson and Cuming Specialty Polymers, a division of National Starch and Chemical Company under the product designation “ECCOBOND 3193-17” is applied to a portion of the container where the module 250 is to be located. The module 250 is then mounted to the container portion.

Next, the heater chip module 250 and the container 22 are heated in an oven at a temperature and for a time period sufficient to effect the curing of the adhesive that joins the heater chip module 250 to the container 22.

A portion of the flexible circuit 190 which is not joined to the spacer 156 is bonded to the container 22 by, for example, a conventional free-standing pressure sensitive adhesive film.

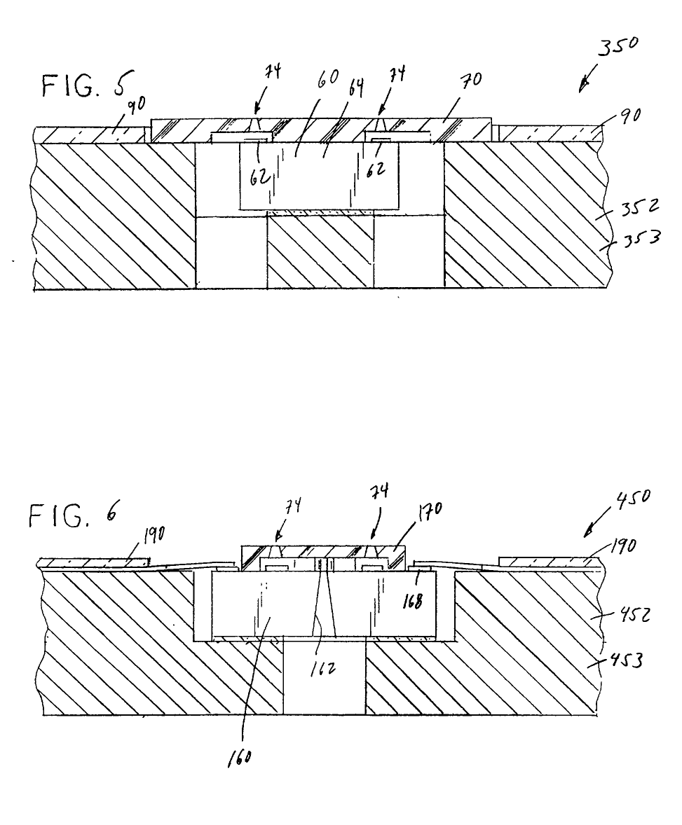

A heater chip module 350, formed in accordance with a third embodiment of the present invention, is shown in FIG. 5, wherein like reference numerals indicate like elements. The heater chip module 350 is constructed in essentially the same manner as the module 50 illustrated in FIG. 2A except that the carrier 352 comprises a substantially rigid, single layer substrate 353. The single layer substrate 353 is preferably formed from a thermally conductive material such as a ceramic, a metal or silicon. In the illustrated embodiment, the single layer substrate 353 is formed from a metal such as stainless steel, e.g., type 316 stainless steel, using any process for making cut metal sheet parts such as is stamping, chemical etching, or laser cutting.

A heater chip module 450, formed in accordance with a fourth embodiment of the present invention, is shown in FIG. 6, wherein like reference numerals indicate like elements. The heater chip module 450 is constructed in essentially the same manner as the module 250 illustrated in FIG. 3 except that the carrier 452 comprises a substantially rigid, single layer substrate 453. The single layer substrate 453 is preferably formed from a thermally conductive material such as a ceramic, a metal or silicon.

What is claimed is:

1. A heater chip module comprising:
a rigid carrier adapted to be secured to a container for receiving ink and including a support section;
a heater chip coupled to said carrier support section, said support section including at least one passage which defines a path for ink to travel from the container to said heater chip; and
a nozzle plate coupled to said heater chip.

2. A heater chip module as set forth in claim 1, wherein said carrier comprises a support substrate and a spacer secured to said support substrate, said spacer having an opening defined by inner side walls, said support substrate having first and second outer surfaces and a portion which defines said carrier support section, an upper surface of said support substrate portion and said inner side walls of said spacer defining an inner cavity of said carrier, said heater chip being positioned in said inner cavity and said at least one passage communicating with said inner cavity.

3. A heater chip module as set forth in claim 2, wherein said inner cavity and said heater chip are sized such that at least one side portion of said heater chip is spaced from at least one of said inner side walls of said spacer.

4. A heater chip module as set forth in claim 2, wherein said heater chip comprises an edge feed heater chip.

5. A heater chip module as set forth in claim 2, wherein said heater chip comprises a center feed heater chip.

6. A heater chip module set forth in claim 2, wherein said spacer is formed from a material selected from the group consisting of ceramic metallic composites, polymers, metals, and ceramics.

7. A heater chip module as set forth in claim 2, wherein said support substrate is formed from a material selected from the group consisting of ceramic metallic composites, metals, and ceramics.

8. A heater chip module as set forth in claim 1, wherein said carrier comprises a single layer substrate.

9. A heater chip module as set forth in claim 8, wherein said heater chip comprises an edge feed heater chip.

10. A heater chip module as set forth in claim 8, wherein said heater chip comprises a center feed heater chip.

11. A heater chip module as set forth in claim 8, wherein said single layer substrate is formed from a material selected from the group consisting of ceramic metallic composites, metals, and ceramics.

12. A flexible circuit/heater chip module assembly comprising:
a heater chip module including a carrier adapted to be secured to a container for receiving ink and including a support section, a heater chip coupled to said carrier support section, and a nozzle plate coupled to said heater chip, said support section including at least one passage which defines a path for ink to travel from the container to said heater chip; and
a flexible circuit coupled to said heater chip.

13. An assembly as set forth in claim 12, wherein said carrier comprises a support substrate and a spacer secured to said support substrate, said spacer having an opening defined by inner side walls, said support substrate having first and second outer surfaces and a portion which defines said carrier support section, an upper surface of said support substrate portion and said inner side walls of said spacer defining an inner cavity of said carrier, said heater chip being positioned in said inner cavity and said at least one passage communicating with said inner cavity.

14. An assembly as set forth in claim 13, wherein said inner cavity and said heater chip are sized such that at least one side portion of said heater chip is spaced from at least one of said inner side walls of said spacer.

15. An assembly as set forth in claim 13, wherein said heater chip comprises an edge feed heater chip.

16. An assembly as set forth in claim 13, wherein said heater chip comprises a center feed heater chip.

17. An assembly as set forth in claim 13, wherein said spacer is formed from a material selected from the group consisting of ceramic metallic composites, polymers, metals, and ceramics.

18. An assembly as set forth in claim 13, wherein said support substrate is formed from a material selected from the group consisting of ceramic metallic composites, metals, and ceramics.

19. An assembly as set forth in claim 12, wherein said carrier comprises a single layer substrate.

20. An assembly as set forth in claim 19, wherein said heater chip comprises an edge feed heater chip.

21. An assembly as set forth in claim 19, wherein said heater chip comprises a center feed heater chip.

22. An assembly as set forth in claim 19, wherein said single layer substrate is formed from a material selected from the group consisting of ceramic metallic composites, metals, and ceramics.

23. An assembly as set forth in claim 12, wherein said flexible circuit comprises a substrate portion and at least one conductor trace on said substrate portion, said at least one conductor trace having a section which is coupled to a bond pad on said heater chip.

24. An assembly as set forth in claim 23, where said conductor trace section is wire bonded to said bond pad.

25. An assembly as set forth in claim 23, where said conductor trace section is TAB bonded to said bond pad.

26. An ink jet print cartridge comprising:
a container adapted to receive ink;
a heater chip module including a substantially rigid carrier secured directly to said container and including a support section, a heater chip coupled to said carrier support section, and a nozzle plate coupled to said heater chip, said support section including at least one passage which defines a path for ink to travel from the container to said heater chip; and
a flexible circuit coupled to said heater chip.

27. An ink jet print cartridge as set forth in claim 26, wherein said heater chip comprises an edge feed heater chip.

28. An ink jet print cartridge as set forth in claim 26, wherein said heater chip comprises a center feed heater chip.

29. A flexible circuit/heater chip assembly comprising:
a heater chip having a base with first and second outer surfaces and at least one bond pad provided on said first base surface;
a nozzle plate coupled to said heater chip so as to be adjacent to said first base surface; and
a flexible circuit including a substrate portion and at least one conductor trace on said substrate portion, said at least one conductor trace having a section which is wire-bonded to said bond pad on said heater chip base such that a wire extends from said trace section to said bond pad.

30. A flexible circuit/heater chip assembly as set forth in claim 29, wherein said trace section and said bond pad are substantially coplanar with a bottom surface of said nozzle plate.

31. A flexible circuit/heater chip assembly as set forth in claim 29, wherein said heater chip is provided with a plurality of bond pads and said flexible circuit is provided with a like number of traces having sections which are wire bonded to said bond pads.
